(19) United States
(12) Patent Application Publication
(10) Pub. No.: US 2024/0105947 A1
(43) Pub. Date: Mar. 28, 2024

(54) All-Solid-State Battery

(71) Applicant: TOYOTA JIDOSHA KABUSHIKI KAISHA, Toyota-shi Aichi-ken (JP)

(72) Inventor: Toru KIDOSAKI, Miyoshi-shi Aichi-ken (JP)

(73) Assignee: TOYOTA JIDOSHA KABUSHIKI KAISHA, Toyota-shi Aichi-ken (JP)

(21) Appl. No.: 18/369,877

(22) Filed: Sep. 19, 2023

(30) Foreign Application Priority Data
Sep. 26, 2022 (JP) 2022-152513

(51) Int. Cl. H01M 4/62; H01M 10/0562

(52) U.S. Cl. CPC H01M 4/621; H01M 10/0562; H01M 2300/0068

(57) ABSTRACT

An all-solid-state battery includes an electrode layer. The electrode layer includes an active material and a sulfide solid electrolyte. In the electrode layer, the sulfide solid electrolyte satisfies a relationship represented by the following formula (1): “C₁/(C₁+C₂+C₃)>0.5”. C₁, C₂, and C₃ each represent an abundance ratio of a skeleton structure unit included in the sulfide solid electrolyte. C₁ represents an abundance ratio of a PS₄³⁻ unit. C₂ represents an abundance ratio of a P₂Sₓ unit. C₃ represents an abundance ratio of a POₓ unit.

### CROSS REFERENCE TO RELATED APPLICATIONS

This nonprovisional application is based on Japanese Patent Application No. 2022-152513 filed on Sep. 26, 2022 with the Japan Patent Office, the entire contents of which are hereby incorporated by reference.

### BACKGROUND

### Field

The present disclosure relates to an all-solid-state battery.

### Description of the Background Art

Japanese Patent Application Laid-Open No. 2020-173992 discloses a sulfide solid electrolyte.

### SUMMARY

A resistance of an all-solid-state battery is gradually increased due to repetition of charging/discharging cycles. A resistance increase rate is found by dividing a resistance at a predetermined cycle number by an initial resistance. It is an object of the present disclosure to decrease the resistance increase rate.

1. In one aspect of the present disclosure, an all-solid-state battery includes an electrode layer. The electrode layer includes an active material and a sulfide solid electrolyte. In the electrode layer, the sulfide solid electrolyte satisfies a relationship represented by the following formula (1):

C₁/(C₁+C₂+C₃)>0.5 (1)

In the formula (1), C₁, C₂, and C₃ each represent an abundance ratio of a skeleton structure unit included in the sulfide solid electrolyte. C₁ represents an abundance ratio of a PS₄³⁻ unit. C₂ represents an abundance ratio of a P₂Sₓ unit. C₃ represents an abundance ratio of a POₓ unit.

The sulfide solid electrolyte is promising as an ion conduction path for a bulk type all-solid-state battery. This is because the sulfide solid electrolyte has both high ion conductivity and moldability. Hereinafter, the “solid electrolyte” may be abbreviated as “SE”. For example, the sulfide solid electrolyte may be abbreviated as “sulfide SE”.

The sulfide SE may include a plurality of skeleton structure units. The sulfide SE includes, for example, the PS₄³⁻ unit and the P₂Sₓ unit. The abundance ratio of each unit may be specified by XPS (X-ray Photoelectron Spectroscopy). During the charging/discharging cycle, the sulfide SE is exposed to a high potential and accordingly undergoes oxidative decomposition. The oxidative decomposition of the sulfide SE is considered to produce the POₓ unit. The POₓ unit is a low ion conducting phase. It is considered that the POₓ unit can promote increase in resistance.

The PS₄³⁻ unit is a high ion conducting phase. According to a new finding of the present disclosure, when the abundance ratio of the PS₄³⁻ unit exceeds 50%, the POₓ unit tends to be less likely to be generated. It is considered that the oxidation resistance of the sulfide SE is improved by the PS₄³⁻ unit forming the basic skeleton of the sulfide SE. Therefore, when the abundance ratio of the PS₄³⁻ unit exceeds 50%, a decrease in resistance increase rate is expected. However, conventionally, in an electrode layer of the all-solid-state battery, the abundance ratio of the PS₄³⁻ unit of the sulfide SE is 50% or less.

The sulfide SE is used in a powder form. For particle size adjustment, the sulfide SE is pulverized after being synthesized. That is, mechanical energy is applied to the sulfide SE. According to a further new finding of the present disclosure, in the sulfide SE to which mechanical energy is applied, the abundance ratio of the PS₄³⁻ unit in the electrode layer can be decreased to 50% or less. Thus, for example, by using the sulfide SE that has not been subjected to the pulverization process, the abundance ratio of the PS₄³⁻ unit in the sulfide SE in the electrode layer can be more than 50%.

2. In the all-solid-state battery described in “1”, the sulfide solid electrolyte may further satisfy, for example, a relationship represented by the following formula (2):

C₂/(C₁+C₂+C₃)<0.3 (2)

3. In the all-solid-state battery described in “1” or “2”, the sulfide solid electrolyte may further satisfy, for example, a relationship represented by the following formula (3):

C₃/(C₁+C₂+C₃)<0.2 (3)

4. In the all-solid-state battery according to any one of “1” to “3”, the sulfide solid electrolyte may further satisfy, for example, a relationship represented by the following formula (4):

C₂/C₁<0.4 (4)

5. In one aspect of the present disclosure, an all-solid-state battery includes a positive electrode layer. The positive electrode layer includes an active material and a sulfide solid electrolyte. In the positive electrode layer, the sulfide solid electrolyte satisfies relationships represented by the following formulae (1) to (4):

C₁/(C₁+C₂+C₃)>0.5 (1);

C₂/(C₁+C₂+C₃)<0.3 (2);

C₃/(C₁+C₂+C₃)<0.2 (3);

and

C₂/C₁<0.4 (4)

In each of the formulae (1) to (4), C₁, C₂, and C₃ each represent an abundance ratio of a skeleton structure unit included in the sulfide solid electrolyte. C₁ represents an abundance ratio of a PS₄³⁻ unit. C₂ represents an abundance ratio of a P₂Sₓ unit. C₃ represents an abundance ratio of a POₓ unit.

The positive electrode layer has a higher potential than that of a negative electrode layer. In the positive electrode layer, the sulfide SE tends to be likely to be oxidized and deteriorated. Since the abundance ratio of the PS₄³⁻ unit is high in the positive electrode layer, it is expected that the resistance increase rate is decreased.

An embodiment of the present disclosure (hereinafter, also referred to as “the present embodiment”) and an example of the present disclosure (hereinafter, also referred to as “the present example”) will be described below. However, the present embodiment and the present example do not limit the technical scope of the present disclosure. The present embodiment and the present example are illustrative in any respect. The present embodiment and the present example are non-restrictive. The technical scope of the present disclosure encompasses all the modifications within the scope and meaning equivalent to the description of the claims. For example, it has been initially expected to extract certain configurations from the present embodiment and the present example and combine them freely.

In the present specification, the terms “comprise”, “include”, and “have” as well as their variants (such as “be composed of”) are open-end expressions. Each of the open-end expressions may or may not further include additional element(s) in addition to the stated element(s). The expression “consist of” is a closed expression. It should be noted that even the closed expression does not exclude impurit(ies) that are involved in normal cases, as well as additional element(s) irrelevant to the technology of the present disclosure. The expression “consist essentially of” is a semi-closed expression. The semi-closed expression permits addition of element(s) that do not essentially affect basic and novel characteristics of the technology of the present disclosure.

A numerical range such as “m to n %” includes the lower and upper limit values unless otherwise stated particularly. That is, “m to n %” indicates a numeric value range of “m % or more and n % or less”. Moreover, the expression “m % or more and n % or less” includes “more than m % and less than n %”.

A measurement value can be an average value in multiple measurements. The number of measurements may be more than or equal to 3, more than or equal to 5, or more than or equal to 10. In general, as the number of measurements is larger, the reliability of the average value is expected to become higher. The measurement value can be rounded off based on the number of digits of the significant figure. The measurement value can include an error resulting from a detection limit of a measurement apparatus or the like.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a first conceptual diagram of an all-solid-state battery according to the present embodiment.

FIG. 2 is a second conceptual diagram of the all-solid-state battery according to the present embodiment.

FIG. 3 shows abundance ratios of skeleton structure units in Nos. 1 and 8.

### DESCRIPTION OF THE EMBODIMENTS

1. All-Solid-State Battery

FIG. 1 is a first conceptual diagram of an all-solid-state battery according to the present embodiment. FIG. 1 conceptually shows a cross section parallel to the thickness direction of the first battery 100. The first battery 100 includes a first power generation element 150. The first battery 100 may include, for example, an exterior body (not shown). The exterior body may house the first power generation element 150. The exterior body may be, for example, a pouch made of a metal foil laminate film or a metal case. The first battery 100 may include one first power generation element 150 alone or a plurality of first power generation elements 150. The plurality of first power generation elements 150 may form, for example, a series circuit or a parallel circuit.

The first power generation element 150 includes a first electrode layer 110, a separator layer 130, and a second electrode layer 120. The first power generation element 150 may include a plurality of first electrode layers 110, separator layers 130, and second electrode layers 120. As an example, the first power generation element 150 shown in FIG. 1 includes two first electrode layers 110, two separator layers 130, and two second electrode layers 120. The separator layer 130 is interposed between the first electrode layer 110 and the second electrode layer 120. The separator layer 130 separates the first electrode layer 110 from the second electrode layer 120. The separator layer 130 may include, for example, sulfide SE or the like. The separator layer 130 may have a thickness of, for example, 1 to 100 μm.

The second electrode layer 120 has a polarity different from that of the first electrode layer 110. For example, when the first electrode layer 110 is a positive electrode layer, the second electrode layer 120 is a negative electrode layer. The first power generation element 150 may further include a first current collector 111 and a second current collector 121. The first current collector 111 is in contact with the first electrode layer 110. The second current collector 121 is in contact with the second electrode layer 120. For example, when the first electrode layer 110 is a positive electrode layer, the first current collector 111 is a positive electrode current collector.

For example, when the second electrode layer 120 is a negative electrode layer, the second current collector 121 is a negative electrode current collector. The first current collector 111 and the second current collector 121 may each independently have a thickness of, for example, 5 to 50 μm. Each of the first current collector 111 and the second current collector 121 may independently include, for example, an Al foil, an Al alloy foil, a Cu foil, a Ni foil, a stainless steel foil, or the like.

1-1. Electrode Layer

The first electrode layer 110 and the second electrode layer 120 are generically referred to as “electrode layers”. That is, the electrode layer may be either a positive electrode layer or a negative electrode layer. The electrode layer may have a thickness of, for example, 1 to 1000 μm, 5 to 500 μm, or 10 to 100 μm. The electrode layer includes an active material and a sulfide SE. The electrode layer may further include, for example, a conductive material, a binder, and the like. The electrode layer may comprise, for example, from 1 to 10% binder, from 0 to 10% conductive material, from 1 to 30% sulfide SE, and the remainder of the active material in mass fraction. The remainder may contain, for example, unavoidable impurities, additives, and the like in addition to the active material.

1-1-1. Sulfide Solid Electrolyte

Sulfide SE may form an ion conducting path in the electrode layer. Sulfide SE is a particle group (powder state). The sulfide SE is dispersed in the electrode layer. Sulfide SE may have a D50 of, for example, 0.05 to 5 μm. “D50” denotes a particle diameter at which the accumulated frequency from the side where the particle diameter is small reaches 50% in the particle diameter distribution based on volume. The D50 of sulfide SE may be, for example, 0.1 to 1.5 μm, 0.1 to 1 μm, 0.1 to 0.7 μm, 0.1 to 0.5 μm, 0.1 to 0.3 μm, or 0.1 to 0.15 μm. Sulfide SE may have, for example, a BET specific surface area of 4 to 40 m²/g. The “BET specific surface area” can be measured by gas adsorption (single-point BET method). The BET specific surface area of sulfide SE may be, for example, 8 to 32 m²/g, 10 to 32 m²/g, 14 to 32 m²/g, 18 to 32 m²/g, 23 to 32 m²/g, or 29 to 32 m²/g.

The sulfide SE may be, for example, a glass ceramic type or an argyrodite type. Sulfide SE includes Li, S, and P. The sulfide SE may further contain, for example, Cl, Br, I, O, etc. Sulfide SE may comprise a plurality of skeleton structure units. Sulfide SE includes a PS₄³⁻ unit and a P₂Sₓ unit. The sulfide SE may further comprise a POₓ unit. The abundance ratio of each unit can be measured by an XPS device. The measurement sample (a part of the electrode layer) is collected from the battery. A P2p spectrum and an S2p spectrum are obtained. Peak separation may identify the abundance ratio of each unit. The setting of the XPS apparatus is as follows, for example. The apparatus is an example, and equivalents to the following apparatus may be used. In some embodiments, the settings may vary depending on the device.
XPS Device: Product name “VersaProbe III”, manufactured by Ulvac Phi
X-ray Source: mono-AlKα (hv=1486. 6 eV)
Photoelectron extraction angle: 45°
X-ray beam diameter: 100 μm
Analysis location: Sample center, rectangular range (500 μm×300 μm)

C₁ represents the abundance ratio of PS₄³⁻ unit. C₂ represents the abundance ratio of P₂Sₓ unit. C₃ represents the abundance ratio of POₓ unit. “C₁+C₂+C₃=1” may be used. For example, “C₁+C₂+C₃” may not become 1 due to the presence of components not classified into three kinds of units. “C₁+C₂+C₃” may be, for example, 0.90 to 1.10, or 0.95 to 1.08.

The PS₄³⁻ unit is a high ion conducting phase. When “C₁/(C₁+C₂+C₃)” is greater than 0.5, generation of a POₓ unit (low ion conduction phase) can be suppressed. The higher the abundance ratio of PS₄³⁻ unit, the more expected the resistance is reduced. “C₁/(C₁+C₂+C₃)” may be, for example, 0.6 to 1, 0.7 to 1, 0.8 to 1, or 0.9 to 1. “C₁/(C₁+C₂+C₃)” may be, for example, 0.67 to 0.72.

The “x” of the P₂Sₓ unit is a number greater than or equal to 1. “C₂/(C₁+C₂+C₃)” may be, for example, less than 0.3. “C₂/(C₁+C₂+C₃)” may be, for example, 0 to 0.25, 0.1 to 0.25, or 0.19 to 0.24.

The abundance ratio of the P₂Sₓ unit is lower than the abundance ratio of the PS₄³⁻ unit. “C₂/C₁” may be, for example, less than 0.4. “C₂/C₁” may be, for example, 0.34 or less, or 0.30 or less. “C₂/C₁” may be, for example, 0.01 or more, 0.1 or more, 0.2 or more, or 0.29 or more.

The “x” of the POₓ unit is any number. “C₃/(C₁+C₂+C₃)” may be, for example, less than 0.2. “C₃/(C₁+C₂+C₃)” may be, for example, 0.15 or less, 0.12 or less, 0.1 or less, 0.09 or less, or 0.07 or less. The abundance ratio of the POₓ unit may be, for example, zero.

The abundance ratio of each unit may correspond to amount-of-substance fraction (molar fraction). Sulfide SE may comprise, for example, 0 to 15% of POₓ unit, 0.1 to 24% of P₂Sₓ unit, and the remainder of PS₄³⁻ unit, in amount-of-substance fractions.

Sulfide SE may be synthesized by any method. The sulfide SE can be synthesized by, for example, a vapor phase method, a solid phase method, a liquid phase method, or the like. Sulfide SE may be synthesized from Li₂S and P₂S₅, for example. In the electrode layer, sulfide SE may be synthesized and the electrode layer may be formed such that the abundance ratio of PS₄³⁻ unit exceeds 50%. In order to increase the abundance ratio of the PS₄³⁻ unit in the electrode layer, it is conceivable to reduce the mechanical energy applied to the sulfide SE in the process of forming the electrode layer. In particular, in the crushing treatment of sulfide SE, large mechanical energy may be applied to sulfide SE. For example, by avoiding the crushing treatment (mechanical particle size adjustment), it is expected that the abundance ratio of the PS₄³⁻ unit is increased.

1-1-2. Active Material

The active material causes an electrode reaction. The active material may be, for example, a particle group. The active material may have a D50 of, for example, 1 to 30 μm. The active material may contain hollow particles or solid particles. A “hollow particle” refers to a particle whose cross-sectional area of the cavity at the center is 30% or more of the cross-sectional area of the whole particle in a cross-sectional image of the particle (e.g., an electron microscope image). A “solid particle” refers to a particle whose cross-sectional area of the cavity at the center is less than 30% of the cross-sectional area of the whole particle in a cross-sectional image of the particle.

The active material may be a positive electrode active material. The positive electrode active material may contain, for example, at least one selected from the group consisting of LiCoO₂, LiNiO₂, LiMnO₂, LiMn₂O₄, Li(NiCoMn)O₂, Li(NiCoAl)O₂, Li(NiCoMnAl)O₂, and LiFePO₄. For example, “(NiCoMn)” in “Li(NiCoMn)O₂” indicates that the sum of the composition ratios in parentheses is 1. The active material may be a negative electrode active material. The negative electrode active material may contain, for example, at least one selected from the group consisting of natural graphite, artificial graphite, soft carbon, hard carbon, Si, SiOₓ (0<x<2), Si-based alloy, Sn, SnOₓ(0<x<2), Li, Li-based alloy, and Li₄Ti₅O₁₂.

1-1-3. Conductive Materials

The conductive material may form an electron conduction path in the electrode layer. The conductive material may include, for example, at least one selected from the group consisting of acetylene black (AB), vapor grown carbon fiber (VGCF), carbon nanotubes (CNT) and graphene flakes (GF).

1-1-4. Binder

The binder may bond the solid materials together. The binder may contain, for example, at least one selected from the group consisting of styrene-butadiene rubber (SBR), polyvinylidene difluoride (PVDF), and vinylidene fluoride-hexafluoropropylene copolymer (PVDF-HFP).

1-2. Bipolar Structure

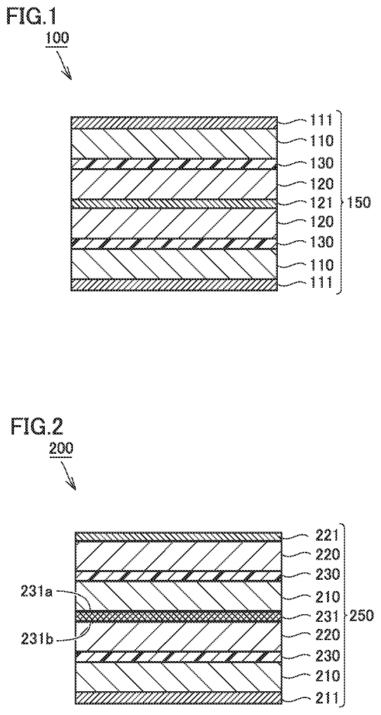

FIG. 2 is a second conceptual diagram of the all-solid-state battery according to the present embodiment. The second battery 200 includes a second power generation element 250. The second power generation element 250 has a bipolar structure. The “bipolar structure” indicates a structure in which a positive electrode layer is disposed on one surface of a current collector and a negative electrode layer is disposed on the other surface. On the other hand, a structure (FIG. 1) in which only the electrode layer of one polarity is disposed on one current collector is a “unipolar structure”.

In the bipolar structure, the third current collector 231 includes a first main surface 231a and a second main surface 231b. The second main surface 231b is a surface opposite to the first main surface 231a. The first electrode layer 210 is disposed on the first main surface 231a. The second electrode layer 220 is disposed on the second main surface 231b. The second electrode layer 220 has a polarity different from that of the first electrode layer 210. The separator layer 230 separates the first electrode layer 210 from the second electrode layer 220. The third current collector 231 may include, for example, an Al—Ni cladding material, a single-sided Ni-plated Al foil, or the like. In the second power generation element 250, the first current collector 211 may be disposed at one end in the stacking direction, and the second current collector 221 may be disposed at the other end.

By employing the bipolar structure, a reduction in resistance is expected. In the bipolar structure, the electrode layer tends to have a higher potential than the unipolar structure. In the bipolar structure, it is considered that oxidation degradation of sulfide SE tends to proceed. In the electrode layer included in the bipolar structure, since the abundance ratio of the PS₄³⁻ unit is high, it is expected that the resistance increase rate is reduced.

### EXAMPLES

2. Production of all-Solid-State Battery

2-1. No. 1

2-1-1. Synthesis of Sulfide SE

The Li₂S and P₂S₅ were weighed to prepare a raw material powder. The mixture ratio of Li₂S and P₂S₅ in the raw material powder was “Li₂S/P₂S₅=75/25 (molar ratio)”. Raw material powder and tetrahydrofuran (THF) were charged into a glass container. The mixture ratio of raw material and THF was “material powder/THF=1/20 (mass ratio)”. At 25° C., the raw material powder and THF were stirred for 72 hours. After stirring, a precipitate (powder) was collected. The precipitate is a precursor of sulfide SE. The precursor was dried at 25° C. under an argon atmosphere to forma dried product. The dried product was fired under atmospheric pressure (open system) at 100° C. for 1 hour to form a fired product. The fired product was vacuum sealed in a quartz tube. The quartz tube was fired in a muffle furnace at 140° C. for 12 hours to obtain sulfide SE. Hereinafter, the sulfide SE is also referred to as “LPS”.

2-1-2. Formation of Positive Peripheral Layer

As a kneading apparatus, “Filmix (registered trademark)” manufactured by Primix Co., Ltd. was prepared. 80 parts by mass of a positive electrode active material (LiNi_{1/3}Co_{1/3}Mn_{1/3}O₂), 9.51 parts by mass of sulfide SE (LPS), and 2 parts by mass of a conductive material (VGCF) were charged into a mixing vessel of a fill mix. Then, a binder dispersion (SBR dispersion, concentration: 5%) and 32.21 parts by mass of a dispersion medium (tetralin) were charged into a mixing vessel. The solids fraction was 69% (mass fraction). The mixture was kneaded to form a positive electrode slurry. During kneading, the peripheral speed of the fill mix was adjusted in the range of 5 to 30 m/s. A positive electrode slurry was applied to both surfaces of a positive electrode current collector (Ni foil) by a blade-type applicator to form a positive electrode layer. The positive electrode layer was dried at 100° C. for 30 minutes.

2-1-3. Formation of Negative Electrode Layer

A high speed shear PC wheel was set in the fill mix. In the fill mix, 18.6 parts by mass of a negative electrode active material (Si), 8.69 parts by mass of sulfide SE (LPS), 2.4 parts by mass of a conductive material (VGCF), a binder dispersion (SBR dispersion, concentration 5%), and a dispersion medium (diisobutyl ketone) were mixed to form a negative electrode slurry. The solid content of the negative electrode slurry was 43% (mass fraction). During kneading, the peripheral speed of the fill mix was adjusted in the range of 5 to 30 m/s. The negative electrode slurry was applied to one surface of the base material (Al foil) by a blade-type applicator to form a negative electrode layer. The positive electrode layer was dried at 100° C. for 30 minutes. The negative electrode layer was densified by a roll press machine.

2-1-4. Formation of Separator Layer

Acrylate-butadiene rubber (ABR) was dissolved in heptane to form a binder solution. The concentration of ABR in the binder solution was 5% (mass fraction). 40 parts by weight of sulfide SE (LPS), 8 parts by weight of binder solution, 25.62 parts by weight of heptane, and 8 parts by weight of dibutyl ether were mixed by an ultrasonic homogenizer to form a separator slurry. The separator slurry was applied to the surface of the base material (Al foil) to form a separator layer. The separator layer was dried at 100° C. for 30 minutes.

2-1-5. Assembly

The separator layer was pressed and transferred to the positive electrode layer by press working at 20 kN. The positive electrode layer and the separator layer were collectively densified by roll pressing. The roll linear pressure was 4 ton/cm, and the roll gap was 100 μm. The negative electrode layer (densified) was compressed and transferred to the separator layer to form a power generation element. A lead tab was attached to the power generation element. As an exterior body, a pouch made of an Al laminate film was prepared. The power generation element was enclosed in the exterior body. A restraint member was attached to the outside of the exterior body so that a pressure of 20 MPa was applied to the power generation element. Thus, a test battery was manufactured.

2-2. Nos. 2 to 7

A test battery was produced in the same manner as in No. 1 except that sulfide SE was synthesized so that D50 of sulfide SE became the value in Table 1 below.

2-3. Nos. 8 to 14

A test battery was produced in the same manner as in Nos. 1 to 7, except that the D50 of the sulfide SE was adjusted by performing the crushing treatment after the synthesis of the sulfide SE.

3. Evaluation

CCCV charge/discharge (upper limit charge voltage: 4.55 V, lower limit discharge voltage: 2.5 V) was performed. The design capacity of the cell was 0.3 Ah. The time rate during CC charge and CC discharge was 0.1 C. At a time rate of 1 C, the design capacity is discharged in one hour. A charge/discharge cycle was performed for 100 cycles. The resistance increase rate was determined by dividing the resistance after 100 cycles by the initial resistance. In this evaluation, the resistance after three cycles was regarded as the “start resistance”. The resistance increase rates in Table 1 below are expressed in percentages.

By disassembling the test battery, the positive electrode layer was recovered from the inside of the test battery. The XPS device measured the abundance ratio of each unit in the LPS of the positive electrode layer.

TABLE 1

| | Electrode Layer (Positive Electrode Layer) | | | | | | | Evaluation |
|---|---|---|---|---|---|---|---|---|
| | Solid Electrolyte | | | XPS Skeleton Structure Unit Abundance Ratio | | | | Cycle Test |
| | | | Mechanical | PS₄³⁻ Unit | P₂Sₓ Unit | POₓ Unit | | Resistance |
| | D50 | BET | Particle Size | C₁/(C₁ + C₂ + C₃) | C₂/(C₁ + C₂ + C₃) | C₃/(C₁ + C₂ + C₃) | C₂/C₁ | Increase Rate |
| No. | [μm] | [m²/g] | Adjustment | [—] | [—] | [—] | [—] | [%] |
| 1 | 0.1 | 32 | Not Performed | 0.71 | 0.21 | 0.08 | 0.30 | 92 |
| 2 | 0.15 | 29 | Not Performed | 0.69 | 0.22 | 0.07 | 0.32 | 91 |
| 3 | 0.3 | 23 | Not Performed | 0.72 | 0.21 | 0.15 | 0.29 | 94 |
| 4 | 0.5 | 18 | Not Performed | 0.7 | 0.24 | 0.07 | 0.34 | 89 |
| 5 | 0.7 | 14 | Not Performed | 0.67 | 0.19 | 0.09 | 0.28 | 91 |
| 6 | 1 | 10 | Not Performed | 0.69 | 0.22 | 0.1 | 0.32 | 90 |
| 7 | 1.5 | 8 | Not Performed | 0.7 | 0.24 | 0.12 | 0.34 | 92 |
| 8 | 0.1 | 32 | Performed | 0.42 | 0.37 | 0.21 | 0.88 | 192 |
| 9 | 0.15 | 29 | Performed | 0.41 | 0.35 | 0.21 | 0.85 | 183 |
| 10 | 0.3 | 23 | Performed | 0.40 | 0.34 | 0.22 | 0.85 | 193 |
| 11 | 0.5 | 18 | Performed | 0.43 | 0.36 | 0.25 | 0.84 | 190 |
| 12 | 0.7 | 14 | Performed | 0.46 | 0.37 | 0.22 | 0.80 | 182 |
| 13 | 1 | 10 | Performed | 0.42 | 0.35 | 0.23 | 0.83 | 192 |
| 14 | 1.5 | 8 | Performed | 0.43 | 0.34 | 0.24 | 0.79 | 196 |

4. Results

In Nos. 1 to 7, mechanical particle size adjustment is not performed after synthesis of the sulfide SE. In Nos. 1 to 7, the abundance ratio of the PS₄³⁻ unit is large. In Nos. 1 to 7, “C₁/(C₁+C₂+C₃)” exceeds 0.5. In Nos. 1 to 7, the resistance increase rate is lower than in Nos. 8 to 14.

In Nos. 8 to 14, mechanical particle size adjustment is performed after synthesis of the sulfide SE. In Nos. 8 to 14, the abundance ratio of the PS₄³⁻ unit decreases. In Nos. 8 to 14, “C₁/(C₁+C₂+C₃)” is 0.5 or less. In Nos. 8 to 14, the abundance ratio of the POₓ unit is increased as compared with Nos. 1 to 7. In Nos. 8 to 14, the abundance ratio of the P₂Sₓ unit is increased as compared with Nos. 1 to 7.

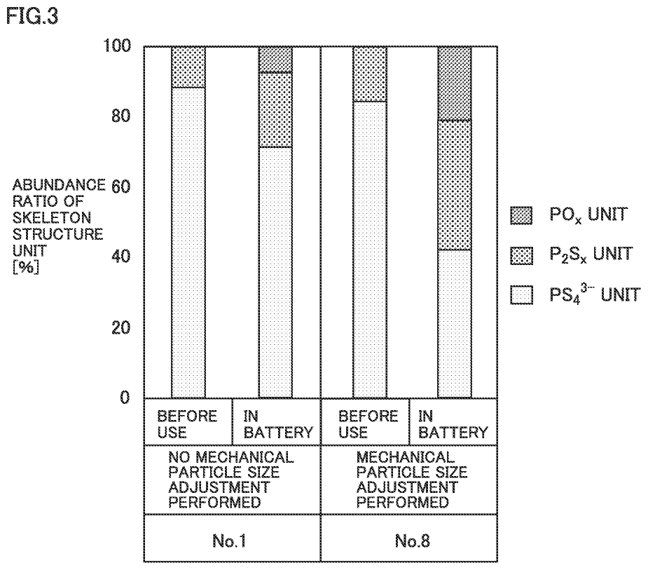

FIG. 3 shows abundance ratios of skeleton structure units in Nos. 1 and 8. On the vertical axis of the graph, “C₁/(C₁+C₂+C₃))” and the like are displayed in percentages. In the sulfide SE powder before use (before formation of the positive electrode layer), both No. 1 and No. 8 have a PS₄³⁻ unit abundance ratio of more than 50%. In the sulfide SE powder before use, the difference between No. 1 and No. 8 is small. However, in the sulfide SE of the positive electrode layer recovered from the test battery, there is a large difference between No. 1 and No. 8. That is, the abundance ratio of the PS₄³⁻ unit in No. 1 exceeds 50%. The abundance ratio of the PS₄³⁻ unit in No. 8 is 50% or less. The generation amount of the POₓ unit in No. 1 is smaller than the generation amount of the POₓ unit in No. 8. As described above, the sulfide SE of No. 1 is not subjected to mechanical particle size adjustment, and the sulfide SE of No. 8 is subjected to mechanical particle size adjustment.

What is claimed is:

1. An all-solid-state battery comprising:
an electrode layer, wherein
the electrode layer includes an active material and a sulfide solid electrolyte,
in the electrode layer, the sulfide solid electrolyte satisfies a relationship represented by the following formula (1):
C₁/(C₁+C₂+C₃)>0.5 (1)
in the formula (1), C₁, C₂, and C₃ each represent an abundance ratio of a skeleton structure unit included in the sulfide solid electrolyte,
C₁ represents an abundance ratio of a PS₄³⁻ unit,
C₂ represents an abundance ratio of a P₂Sₓ unit, and
C₃ represents an abundance ratio of a POₓ unit.

2. The all-solid-state battery according to claim 1, wherein
the sulfide solid electrolyte further satisfies a relationship represented by the following formula (2):
C₂/(C₁+C₂+C₃)<0.3 (2).

3. The all-solid-state battery according to claim 1, wherein
the sulfide solid electrolyte further satisfies a relationship represented by the following formula (3):
C₃/(C₁+C₂+C₃)<0.2 (3).

4. The all-solid-state battery according to claim 1, wherein the sulfide solid electrolyte further satisfies a relationship represented by the following formula (4):
C₂/C₁<0.4 (4).

5. An all-solid-state battery comprising:
a positive electrode layer, wherein
the positive electrode layer includes an active material and a sulfide solid electrolyte,
in the positive electrode layer, the sulfide solid electrolyte satisfies relationships represented by the following formulae (1) to (4):
C₁/(C₁+C₂+C₃)>0.5 (1);
C₂/(C₁+C₂+C₃)<0.3 (2);
C₃/(C₁+C₂+C₃)<0.2 (3);
and
C₂/C₁<0.4 (4)
in each of the formulae (1) to (4), C₁, C₂, and C₃ each represent an abundance ratio of a skeleton structure unit included in the sulfide solid electrolyte,
C₁ represents an abundance ratio of a PS₄³⁻ unit,
C₂ represents an abundance ratio of a P₂Sₓ unit, and
C₃ represents an abundance ratio of a POₓ unit.
